(19) United States
(12) Patent Application Publication
(10) Pub. No.: US 2022/0140645 A1
(43) Pub. Date: May 5, 2022

(54) Device, Method and Cable for Feeding Electrical Energy to an Energy Supply Network, on the Basis of a Mobile Energy Source

(71) Applicant: Bayerische Motoren Werke Aktiengesellschaft, Muenchen (DE)

(72) Inventor: Juergen HILDINGER, Hoehenkirchen-Siegertsbrunn (DE)

(21) Appl. No.: 17/428,382

(22) PCT Filed: Apr. 14, 2020
(86) PCT No.: PCT/EP2020/060440

§ 371 Date: Aug. 4, 2021

(30) Foreign Application Priority Data
May 10, 2019 (DE) 10 2019 112 228.7

(51) Int. Cl. H02J 9/06

(52) U.S. Cl. CPC H02J 9/06

(57) ABSTRACT

A device for feeding electrical energy to an energy supply network, the device being designed to switch between energy from a first energy source and energy from a mobile energy source.

### BACKGROUND AND SUMMARY OF THE INVENTION

The invention relates to a device for feeding electrical energy into an energy grid on the basis of an energy store, to a cable for connecting a mobile energy store to an energy grid and to a method for operating the device.

Battery storage systems that can be used in external energy grids, for example in single-family and multiple-family dwellings or commercial operations, are available as complete systems and have to be fixedly installed in the home or the operation. Mobile battery storage systems, as are used in electrically operated motor vehicles, for example, are often not used for their primary task. They are then practically unused. In contrast, the task of making it possible to improve integration of mobile energy stores and external energy grids arises.

According to a first aspect, the invention relates to a device for feeding electrical energy into an energy grid, wherein the device is set up to switch over between an energy from a first energy source and an energy from a mobile energy store.

An aim of the invention is the additional use of a mobile energy store in an external energy grid. A further aim is the replacement of a stationary energy store with a mobile energy store.

Mobile energy stores are sometimes used for only a few hours a day. This may be the case, for example, when a mobile energy store is arranged in an electric vehicle. The potential for the use of the mobile energy store in an external energy grid is then high. However, mobile energy stores are currently not set up for being used in an external energy grid, that is to say outside of the circuit that they primarily have to supply with power, for example a vehicle circuit. In particular, standardizations and certifications may be necessary for this, which mobile energy stores do not have. In contrast, many external energy grids already have components that are required in order to be operated using a mobile energy store. This is the case, in particular, when the external energy grid is already fed by a decentralized energy source. In particular, the energy grid may already have an inverter, a DC connection and/or corresponding safety devices.

According to one embodiment of the first aspect of the invention, the device is set up to feed energy into a low-voltage grid, in particular a home grid.

Low-voltage grids serve to distribute the electrical energy to the electrical end consumers and to supply power to low-voltage units. They are therefore fed from a superordinate medium-voltage grid, in particular via transformers.

Low-voltage grids can be constructed as three-conductor or four-conductor systems. In particular, they serve to make it possible to supply power to single-phase consumers. They are operated, in particular, with a grid voltage of 100 V to 1000 V. The voltages of individual low-voltage grids can be 250, 400, 630 or 1000 kVA. Outside of Europe, other forms and operating voltages may also be conventional.

Low-voltage grids can be, in particular, also limited to one location, for example a low-voltage grid can be a home grid of a single-family dwelling or a multiple-family dwelling and/or one or more apartments. A low-voltage grid can also be an energy grid of a boat. A low-voltage grid may be a home grid of a private consumer.

According to one embodiment of the first aspect of the invention, the device is set up to switch over energy from a first energy source, which is a decentralized energy source.

A decentralized energy source is an energy source that is not included in the public energy grid. In particular, a decentralized energy source may be a private energy source, in particular a wind energy source, a solar energy source, for example a photovoltaic system, and/or a hydro energy source. Island grids, that is to say the interconnection of a few small power generators, in particular in remote locations that are not connected to the public power grid, also constitute decentralized energy sources in the context of the invention. Wind farms and solar farms are also included in decentralized energy sources in the context of the invention. In particular, the device can also be part of the first energy source and/or can be arranged on the same platform as the first energy source.

According to one embodiment of the first aspect of the invention, the device is set up to feed energy from a high-voltage store as mobile energy store into the energy grid.

A high-voltage store in the context of the invention can be a battery with a terminal voltage greater than 40 V, in particular greater than 60 V DC. A high-voltage store can also be an energy store that is set up to drive electric vehicles. A high-voltage store can consist of several interconnected storage units. Supercapacitors and/or mechanical flywheel energy stores can also be high-voltage stores.

According to one embodiment of the first aspect of the invention, the device is set up to feed energy into the energy grid from a mobile energy store, which is arranged in a vehicle.

A vehicle in the context of the invention can be, for example, a passenger vehicle (Pkw), a commercial vehicle (Lkw) or a motorbike, which is equipped with a mobile electrical energy store. Alternatively, a vehicle in the context of the present invention can also be a boat, which has a mobile electrical energy store. In particular, the device can also be part of the mobile energy store and/or can be arranged on the same platform, in particular on a motor vehicle.

According to one embodiment of the first aspect of the invention, the switchover is carried out on the basis of a predefined parameter, in particular in a manner dependent on time, capacity and/or load.

The device can be configured, for example, so that the energy of the first energy source is fed into the energy grid in a time-dependent manner during the day. For example, a photovoltaic system as first energy source can deliver energy to the energy grid during the day. At night, the device can then be configured so that it feeds energy of the mobile energy store into the energy grid. This is because, if, for example, the first energy source is a photovoltaic system, it cannot normally provide a significant amount of energy to supply power to the energy grid at night. The energy grid must then usually be supplied with power from another energy source. Of course, another time dependency can also be defined, in which there is a switchover from the first energy source to the mobile energy store.

In addition or as an alternative, the switchover can be carried out in a manner dependent on capacity. For example, the switchover can be dependent on the capability of the first energy source of delivering energy and/or on the capability of the mobile energy store of delivering energy. In particular, there can be a switchover from a photovoltaic system as first energy store to the mobile energy store when the sunlight is too low and therefore the photovoltaic system cannot deliver enough energy.

In addition or as an alternative, the switchover can also be carried out in a manner dependent on load. Particularly when a correspondingly low amount of energy is required from the energy grid, there can be a switchover to the mobile energy store. In addition or as an alternative, the device can also be set up to deliver energy to the energy grid from the first energy source and from the mobile energy store. This can be useful, in particular, when the energy demands of the energy grid, that is to say the load, cannot be covered by the first energy source and/or the mobile energy store alone.

In addition or as an alternative, there can be a switchover to a mobile energy store and accordingly a supply of energy to the energy grid from the mobile energy store until the mobile energy store only has a predefined state of charge. This can be advantageous, in particular, in order to operate a home grid by way of the mobile energy store of an electrical motor vehicle as long as it is ensured that a predefined time or a predefined distance can still be covered by the vehicle based on the energy contained in the mobile energy store.

According to one embodiment of the first aspect of the invention, the device is set up to prevent a predefined state of the mobile energy store.

Not operating the device in a predefined state can occur, in particular, for safety reasons. In this case, it may be that the device is set up to no longer draw a predefined amount of energy from the mobile energy store, in particular to no longer allow a predefined current out of the mobile energy store or into the mobile energy store. In particular, the device can comprise a contactor. The contactor can be set up to prevent a short circuit, in particular when a connection between the device and the mobile energy store is established or disconnected. As already mentioned above, a predefined state can also comprise undershooting a certain charging capacity of the mobile energy store. In particular, a predefined state can also be a voltage or a voltage range of the mobile energy source that should not be undershot.

According to a first aspect of the invention, the device is set up to operate the mobile energy store in a predefined state, in particular an optimum state.

The device can be set up, for example, to operate the energy store so that a maximum energy and/or power or an energy (or power) that corresponds approximately to a maximum energy (or power) is drawn from the mobile energy store. In particular, this can be carried out based on a voltage-current characteristic curve (U-I characteristic curve). Commercially available inverters are often guided by a voltage-current profile of a solar energy source or of a stationary energy store, for example. This ensures that a large amount of energy can be drawn from the energy source or the energy store without it resulting in a breakdown of the energy source and/or the energy source or the energy store being damaged. In particular, the device can comprise a plurality of different voltage-current profiles, which are assigned to different energy sources or different energy stores. Then, when a specific energy store or a specific energy source is connected, the appropriate voltage-current profile can be selected, in particular before the energy source or the energy store is loaded. Such a selection can also be carried out in particular automatically, for example by virtue of the device obtaining information about the connected mobile energy source.

According to one embodiment of the first aspect of the invention, the device is set up to exchange information with an external device.

The device can to this end comprise a conventional communication interface, wireless and/or wired. A wireless communication interface can be effected on the basis of Wi-Fi, Bluetooth, Zigbee and/or a 2G, 3G, 4G, 5G and/or a similar mobile radio communication. A wired communication interface can be implemented on the basis of ethernet and/or a professional bus system, for example PROFIBUS and/or CAN bus. The device can be set up to communicate with the energy grid and/or the mobile energy store in order, for example, to exchange information about actuation, in particular information about a U-I characteristic curve and/or other operating parameters.

In addition or as an alternative, the device can be set up to communicate with the home grid, in particular in order to obtain a piece of information about the energy demand required by the home grid.

According to one embodiment of the first aspect of the invention, the device is set up to draw a predetermined power variable from the mobile energy store.

A power variable in the context of the invention can relate to a power, a current, a voltage, a resistance, and/or an energy. In particular, the device can be set up to operate the mobile energy store such that a power variable required for the home grid is not exceeded. In particular, the device can be set up to obtain a piece of information about the energy grid, for example on the basis of a sensor of the energy grid and/or an estimated piece of information, and accordingly to control or to regulate the power variable of the mobile energy store on the basis of the information obtained.

According to one embodiment of the first aspect of the invention, the device is set up to interact with an inverter, in particular to activate same.

The device can be set up, in particular, to be connected to the inverter. Inverters can be designed so that they first have to be activated before they begin their operation. This may be the case, for example, in order to prevent unnecessary losses of electrical energy when the inverter is not being used. In such a case, it may be that an inverter has to be activated using a corresponding signal, for example a predefined current or a predefined voltage. The device can be set up to provide such an activation signal to an inverter. In particular, the device can be set up to correspondingly emulate a signal for activating an inverter, which usually comes from a photovoltaic system, for example, so that the inverter begins operation upon receiving the signal even if the energy is provided by the mobile energy store. This may be advantageous because then an inverter that is actually provided for operation with the first energy source can be used with the device. For example, this may be a commercially available inverter, which is set up for operation with a photovoltaic system and accordingly is also set up to be “awakened” by this photovoltaic system.

In particular, the device can be set up to interact with a commercially available inverter. Such an inverter may be an inverter certified for the operation of the energy grid. In addition or as an alternative, the inverter can be certified to process power from a first energy source, in particular a photovoltaic system.

In particular, the device can also be part of an inverter and/or can be arranged on the same platform as the inverter.

According to one embodiment of the first aspect of the invention, the device is set up to charge the mobile energy store by way of the first energy source and/or the energy grid.

Since mobile energy stores, in particular a battery of an electric vehicle, store direct current, a conversion of alternating current to direct current is necessary when an energy source, such as a public energy grid, for example, only provides alternating current. For this, there are two possibilities for electric vehicles in the prior art: either the on-board charging unit in the vehicle (AC charging) takes over the conversion into direct current and charges the battery, or a rectifier in the charging station (DC charging) converts the current directly and subsequently charges the battery of the electric vehicle. The plugs and sockets can also differ depending on the type of charging.

Many mobile energy stores, for example batteries in an electric vehicle, are suitable for being charged using alternating current. The on-board charging unit of the vehicle converts the alternating current to direct current for this purpose. Depending on the charging unit installed, the AC charging power can vary. For protection and communication with the vehicle, only one AC charging station is required. This ensures a safe and convenient charging of electric vehicles for most home or semi-public places—for instance company premises or parking garages. The plug types for AC charging can be suitable, in particular, for domestic sockets, CEE sockets or type 1 sockets or type 2 sockets.

In mobile energy stores, in particular in some electric vehicles, there is a faster alternative to AC charging: the direct current or else DC charging station. In this case, the current is charged directly into the battery. When the energy is provided by an AC source, the rectifier is installed in a charging station. These charging stations sometimes make possible high charging powers, up to 250 kW. However, DC charging stations are significantly more expensive than AC charging stations and are therefore primarily used in the public sphere. The plug types for DC charging stations can be, for example, CHAdeMO plugs, CCS plugs (combo 2 plugs) or a plug for the Tesla supercharger.

According to one embodiment of the invention, a non-required power of the first energy source can be used to charge the mobile energy store, in particular when the power that can be provided by the first energy source is not fully required in order to supply power to the energy grid. This may be advantageous, in particular, when a direct current is delivered by the first energy source, because then an additional rectification of alternating current to direct current, as takes place in a typical charging unit for the mobile energy store, can be avoided. In this case, the power of the first energy source is transmitted directly to the mobile energy store. This type of charging is also known by the term “DC charging”.

In particular, the energy that is provided by the first energy source can be divided so that one portion is used for DC charging and one portion is fed into the energy grid by way of the device.

The division can be effected, in particular, on the basis of one or more predefined parameters. For example, the division can be effected so that so much energy is expended to charge the mobile energy store that it is charged optimally, in particular optimally in terms of time. The remaining energy can be used to feed the energy grid.

In particular, the DC connection of the device for feeding energy from the mobile energy store and/or for charging the mobile energy store from the first energy source can be combined with the AC connection for charging the mobile energy store from the energy grid.

In particular, a plug and/or a socket for connecting the device can be based on one of the aforementioned plugs and/or sockets.

According to one embodiment of the first aspect of the invention, the device is set up to prevent feedback of the mobile energy store into the first energy source.

According to one embodiment of the first aspect of the invention, the device is set up to control whether the mobile energy store is charged or discharged.

The control can relate on the one hand to the DC charging or the supply of the energy grid with energy from the mobile energy store and thus the control of the energy from the first energy source and/or the mobile energy store.

In addition or as an alternative, the control can relate to the charging via the energy grid, in particular via the inverter of the energy grid. This can be, in particular, AC charging.

According to one embodiment of the first aspect of the invention, the device is set up to be connected to a contactor of a mobile energy store.

In particular, for this purpose the device can comprise a cable, which is based on one of the aforementioned plugs and/or sockets. In particular, the cable can additionally comprise a communication channel according to one or more of the aforementioned wired communication methods.

According to a second aspect of the invention, the device relates to a method for operating a device according to the first aspect of the invention or one of the embodiments of the first aspect.

According to a third aspect, the invention relates to a cable for connecting a mobile energy store to an energy grid and to a first energy source. The cable can establish the connection, in particular, by way of a device according to the first aspect or an embodiment of the first aspect.

In particular, the cable can be based on one of the aforementioned plugs and/or one of the aforementioned sockets. In particular, the cable can have three conductors for AC charging and two conductors for DC charging and/or feeding the energy grid with energy from the mobile energy store. In addition or as an alternative, the cable can have a communication channel in order to make wired communication possible.

### BRIEF DESCRIPTION OF THE DRAWINGS

FIG. 1 shows a block diagram illustrating the operation of a device according to one embodiment of the invention.

FIG. 2 shows an arrangement for illustrating the operation of a device according to a further embodiment of the invention and a cable according to one embodiment of the invention.

### DETAILED DESCRIPTION OF THE DRAWINGS

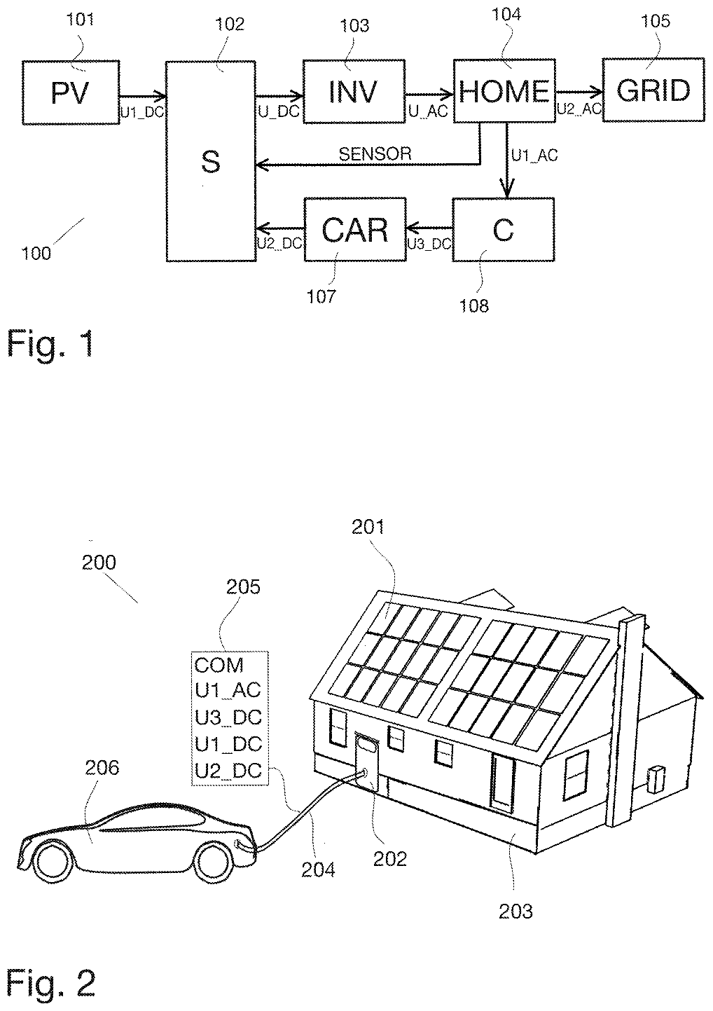

FIG. 1 shows a block diagram illustrating the operation of a system with a device according to one embodiment 102 of the invention. The system 100 comprises a photovoltaic system 101, which normally delivers a direct current U1_DC to the inverter 103. The direct current D1_DC is converted by the inverter to an alternating current UAC and fed into a low-voltage grid, in this case the home grid 104. The home grid is additionally connected to a public energy grid 105, wherein, in particular, energy U2_AC not required by the home grid can be fed back from the photovoltaic system to the public grid. Of course, energy from the public energy grid can also be used to feed the home grid when the energy of the photovoltaic system is not sufficient to cover the energy demand of the home grid.

In order to use the energy from the photovoltaic system even better, an energy store can be used, which is fixedly arranged in the home grid and in which energy of the photovoltaic system is stored when it is required by the home grid. However, such energy stores are expensive.

An alternative to this is using a mobile energy store. As shown in FIG. 1, this can be a mobile energy store, which is arranged in a vehicle 107 in order to electrically operate same. As shown here, such a vehicle can also be charged by way of the home grid 104. For example, this can be carried out by the alternating current U1_AC of the home grid, wherein a rectifier arranged in the vehicle then converts the alternating current U1_AC provided from the home grid to a direct current U3_DC. In the present example, the rectifier can be represented by the block 108, wherein this is then arranged in the vehicle 107. In addition or as an alternative, the alternating current U1_AC provided by the home grid can be used to a direct current U1_DC for charging the mobile energy store even in the home grid or by a rectifier connected to the home grid and not part of the vehicle.

In order to use the mobile energy store 107 of the vehicle more efficiently, in particular even if the vehicle is not required, the device 102 is used according to embodiments of the present invention. Both the mobile energy store 107 and the photovoltaic system 101 can be connected to the device. The device is set up to switch over between the direct current U1_DC from the photovoltaic system and the direct current U2_DC from the mobile energy store and to use in each case one of the energies from the photovoltaic system and the mobile energy store to feed to the home grid 104. In addition, the energies from the photovoltaic system 101 and from the mobile energy store 107 can also be fed into the home grid 104 together by the device 102. The device 102 is set up to provide a direct current U_DC to the inverter 103 already located in the home grid. The inverter transforms the energy to the AC voltage U_AC for the home grid irrespective of whether this energy comes from the photovoltaic system or the mobile energy store.

In order to be able to operate the inverter, the device 102 can emulate an awaken signal in order to transfer the inverter from a standby mode to an operating mode. This signal usually comes directly from the photovoltaic system if this is not connected to the inverter 103 by way of the device 102.

Furthermore, the device 102 can communicate information regarding the drawing of energy from the mobile energy store 107 to the inverter 103. An optimum energy draw from the mobile energy store 107 can differ from an optimum energy draw from the photovoltaic system 101. In particular, the voltage-current characteristic curves can differ. Since the inverter 103 is set up for the photovoltaic system, it comprises only information regarding the energy draw from the photovoltaic system but not information regarding the operation of the mobile energy store 107. This information is provided by the device 102.

In addition, the device 102 comprises a communication interface for receiving a piece of sensor information SENSOR from the home grid 104. The sensor information comprises information regarding the current energy demand of the home grid 104. By using this information, the device 102 can adjust the energy draw from the mobile energy store so that enough energy, but not too much energy, is drawn from the mobile energy store 107 of the motor vehicle in order to operate the home grid 104.

FIG. 2 shows an arrangement 200 for illustrating the operation of a device 202 according to one embodiment of the invention as well as a cable 204 according to one embodiment of the invention. First, a setup 200 of a modern household is illustrated. An electric vehicle 206 is connected to a single-family dwelling 203 via cable 204 by way of a wall box 202 and is usually charged by the electrical grid of the single-family dwelling. The single-family dwelling has a photovoltaic system 201, which provides energy U1_DC for the electrical energy demand of the single-family dwelling 203. The single-family dwelling is additionally connected to a public electrical energy grid (which is not illustrated), into which energy of the photovoltaic system that is not required can be fed and additionally energy is provided to feed to the electrical energy grid of the single-family dwelling, for example when the photovoltaic system delivers too little energy to cover this energy demand.

According to the embodiment of the invention illustrated here, the device 202 is embodied as a wall box. The device 202 is connected to the photovoltaic system and the public energy grid by way of the electrical energy grid of the single-family dwelling and is set up to provide an alternating current U1_AC or a direct current U3_DC for charging the mobile energy store of the vehicle 206 by way of the cable 204.

In addition, the device 202 is set up to draw energy from the mobile energy store of the vehicle 206 and to feed it into the energy grid of the single-family dwelling by way of the inverter (which is not illustrated) of the photovoltaic system. In this case, this energy is the direct current U2_DC that is provided by the mobile energy store, in this case the battery of the vehicle 206. The illustration shows that energy U2_DC from the mobile energy store of the vehicle 206 can be provided to the electrical energy grid of the single-family dwelling using only one single cable and in addition energy from the photovoltaic system can be used directly (DC charging) in order to charge the mobile energy store. Furthermore, the vehicle can be charged from the home grid by way of the cable (DC charging or AC charging), for example with energy from the photovoltaic system that was previously converted by an inverter to an alternating current for the electrical energy grid of the single-family dwelling, or with energy from the public electrical energy grid. In addition, information COM can be exchanged by way of the cable between the home grid 203, the inverter, which is not illustrated, and/or the photovoltaic system 201 and the mobile energy store of the vehicle 206.

### LIST OF REFERENCE SIGNS

100, 200 Operating environment of the invention
101, 201 Photovoltaic system
102, 202 Device (embodiment of the invention)
103 Inverter
104, 203 Home grid
105 Public energy grid
107, 206 Vehicle with mobile energy store
108 Charging unit for the mobile energy store
204 Cable (embodiment of the invention)
205 Signal and energy channels of the cable

1.-17. (canceled)

18. A device for feeding electrical energy into an energy grid, wherein the device is configured to switch over between a first energy from a first energy source and a second energy from a mobile energy store.

19. The device according to claim 18, wherein the energy grid is a low-voltage grid.

20. The device according to claim 18, wherein the energy grid is a home grid.

21. The device according to claim 18, wherein the first energy source is a decentralized energy source.

22. The device according to claim 18, wherein the mobile energy store is a high-voltage store.

23. The device according to claim 18, wherein the mobile energy store is arranged in a vehicle.

24. The device according to claim 18, wherein the switchover is carried out based on a predefined parameter.

25. The device according to claim 24, wherein the predefined parameter depends on at least one of time, capacity or load.

26. The device according to claim 18, wherein the device is further configured to prevent a predefined state of the mobile energy store.

27. The device according to claim 18, wherein the device is further configured to operate the mobile energy store in a predefined state.

28. The device according to claim 27, wherein the predefined state is an optimum state.

29. The device according to claim 18, wherein the device is further configured to exchange information with an external device.

30. The device according to claim 28, wherein the external device comprises at least one of the energy grid, the first energy source or the mobile energy store.

31. The device according to claim 18, wherein the device is further configured to draw a predefined power variable from the mobile energy store.

32. The device according to claim 18, wherein the device is further configured to activate an inverter.

33. The device according to claim 18, wherein the device is further configured to charge the mobile energy store by way of at least one of the first energy source or the energy grid.

34. The device according to claim 18, wherein the device is further configured to prevent feedback of the mobile energy store into the first energy source.

35. The device according to claim 18, wherein the device is further configured to control whether the mobile energy store is charged or discharged.

36. The device according to claim 18, wherein the device is further configured to be connected to a contactor of a mobile energy store.

37. A cable for connecting the mobile energy store to the energy grid and a first energy source via the device according to claim 18.
